(19) United States
(12) Patent Application Publication
(10) Pub. No.: US 2022/0391168 A1
(43) Pub. Date: Dec. 8, 2022

(54) AUDIO CONTROL MODULE AND SYSTEM FOR CONTROLLING SOUND DURING A LIVE PERFORMANCE

(71) Applicant: Soundshell AS, Bjornemyr (NO)

(72) Inventor: Bjorn Sigurdsson, Hamar (NO)

(21) Appl. No.: 17/829,661

(22) Filed: Jun. 1, 2022

(30) Foreign Application Priority Data
Jun. 2, 2021 (NO) 20210697

(51) Int. Cl. G06F 3/16; H04R 3/00; H04H 60/05; H04R 5/04

(52) U.S. Cl. CPC G06F 3/165; H04R 3/005; H04H 60/05; H04R 5/04; H04R 2430/01

(57) ABSTRACT

An audio control module is provided for controlling sound during a live performance, and may for example be one of multiple independent audio control modules, one provided for each performer, as part of an audio control system. The audio control module includes a housing having a bottom, walls, a lid, and at least four audio input connectors configured to receive sound signals via connected electrical signal cables. The audio control module processes the sound signals based at least in part on audio control settings provided via user input (e.g., from the respective performer) associated with one or more of the sound signals. Digital connectors may be configured to communicate with other audio control modules at least by transmitting processed sound signals. A mixer module, where provided as part of the system, may selectively combine sound signals from the audio control modules to provide desired mixed output audio signals.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of Norwegian Patent Application No. 20210697, filed Jun. 2, 2021, and which is hereby incorporated by reference.

### BACKGROUND

The invention regards an audio control module and audio control system.

Music is often played and/or recorded using a device commonly referred to as an audio mixer. An audio mixer is capable of receiving audio signals (input signals) from two or more devices that produce audio signals and outputting audio signals (output signals) to one or more audio devices, such as speakers. An audio mixer usually includes mechanisms to adjust the characteristics of the received audio signals, including mechanisms to adjust gain, to equalize the high, mid, and low ranges of the signals, to pan a stereo signal between the left and right signals, and to adjust the volume (or level) of the signals.

The individual audio signals, having been manipulated by the mechanisms as described above, are then summed into a summed audio signal. The summed audio signal can be further adjusted by a mechanism, such as a compressor mechanism and/or a volume control mechanism to create an audio signal output.

The mechanisms described above are linked to controls accessible by a user of the mixer, who can manipulate the controls to achieve the desired audio signal output. The audio signal output can be outputted to one or more devices for listening and/or recording.

A digital mixer which processes audio signals generally has many input channels and output channels. For each of them, many parameters of a limiter, compressor, equalizer, fader, pan, patch status, ON, and the like can be set, and conversely, it is necessary to set these many parameters in order to make the digital mixer perform action as desired.

The input channels receive and input into the mixer signals from a plurality of microphones, electric or electronic musical instruments and other external equipment (microphone/line input signals), and the signal input section is programmed to perform mixing on the input signals in a desired manner and pass resultant mixing-processed signals to a plurality of output channels constituting a signal output section of the console. Generally, the signals of the individual input channels are amplified by head amplifiers and then delivered to a mixing processing section that adjusts respective frequency characteristics and levels of the signals and then performs mixing on the signals in programmed combinations. After that, each of the thus mix-processed signals is set to a desired output level via an output fader and then passed to one of the output channels.

The systems and devices described above are often sophisticated and expensive and are really only available for professional users and concert organizers or venues. 35 Individual musicians or bands/ensembles must rely on rented equipment which often strains their economy.

It should be noted that even though the invention in the following is described for performing music, it may also be used for other performances such as theater or other kinds of live performances.

### BRIEF SUMMARY

Typical elements in media systems may include one or more instruments capable of generating sounds that can be converted into electrical (or audio) signals, such as one or more electric guitars, bass guitars, acoustic guitars, keyboards, percussion, microphones, synthesizers, and the like, and/or video signals, such as a video recorder. A media system may also include audio and/or video signals recorded on compact discs, digital video discs, records, cassettes, one or more computers and the like. Further, a media system may comprise programs, such as programs capable of being run on a computer or iPad/tablet, that permit manipulation of audio and/or media signals. The number and types of signals that can be input into the devices is limited, and the ability of the devices to permit full integration of the functionalities of a portable media device into a user's media system is limited.

An exemplary object in embodiments as disclosed herein may be to provide an audio control module for controlling sound during a live performance and an audio control system.

A further exemplary object is to provide a system that is capable of permitting a user to integrate the functionalities of one or more portable media devices with one or more components of his or her media system.

In one embodiment an audio control module for controlling sound during a live performance a housing having a bottom, walls, and a lid, at least four input connectors adapted for connecting electrical signal cables, and a processing unit connected to input connectors and adapted to processing signals received through the input connectors.

In one embodiment an audio control system for providing controlled sound output from at least one audio source comprises at least one audio control module according to one of the preceding claims and a mixer module, where the mixer module comprises a number of input connectors for connecting to the audio control modules and a processing unit connected to the input connectors, where the processing unit is adapted to can receive audio signals from the at least one audio control module and combine the signals to provide a desired mixed output audio signal.

The system provides a flexible system comprising an improved signal flow for the 35 audio signals from musician to consumer/listener. Each user/musician has his/her own audio control module for controlling his/her sound and possibly also how he/she receives the audio/sound from the connected users. All the audio control modules can be connected to a mixer unit for further processing in order to provide an optimal overall sound to an audience.

Numerous objects, features and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 shows examples of different audio control modules as disclosed herein.

FIG. 2 provides a closer look on two of the modules of FIG. 1.

FIG. 3 shows an example of a double module.

FIGS. 4a and 4b show an example of a module in two states.

FIG. 5 shows an example of a module in the process of folding/unfolding.

FIG. 6 shows an example of a module unfolded without inserted display.

FIG. 7 shows another view of an example of a module.

FIGS. 8a and 8b show an example of a module with interface for a stand.

FIG. 9 shows an example of a stand leg.

FIGS. 10a to 10d show details of the stand leg.

FIG. 11 shows an example of three types of stands.

FIG. 12 shows an example of a mixer mounted in a stand.

FIG. 13 shows an example of an interface for the software of a mixer.

FIGS. 14a to 14d, 15a to 15d, 16a to 16d, 17a to 17d, 18a to 18d, 19a, 19b, and 20a to 20d show different interfaces used for controlling the mixer.

FIGS. 21a and 21b show examples of different designs of a module.

### DETAILED DESCRIPTION

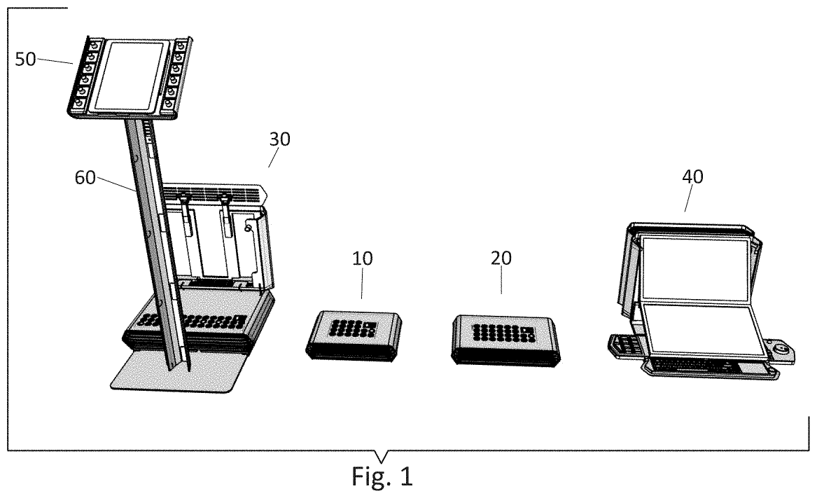

FIG. 1 shows examples of different audio control modules 10, 20, 30, and a mixer module 40 as disclosed herein. The audio control modules and mixer module are each independent modules that can be interconnected to form an audio control system. Each or some of the audio control modules may comprise a stand 50 and a stand leg 60, or one or more stands may be a part of the audio control system.

The audio control modules 10, 20, 30 have basically the same functionality and components, but have different sizes and can be chosen according to the user's needs and economy. The modules each provides the user with the necessary functions to control at least his/her own sound. The modules can be connected 30 together to form a system with full control of the sound output from the system through speakers, providing optimal experience for the listener. This is one of the unique features disclosed herein, making it possible for each performer to acquire his/her own audio control module and together with other performers achieve a complete audio control system. The audio control modules are compact and transportable, which is important for musicians that travel frequently and visit many different venues.

The terms “sound,” “audio output,” and “audio signal” may be used interchangeably throughout the description to represent the product that will be audible to a listener or audience.

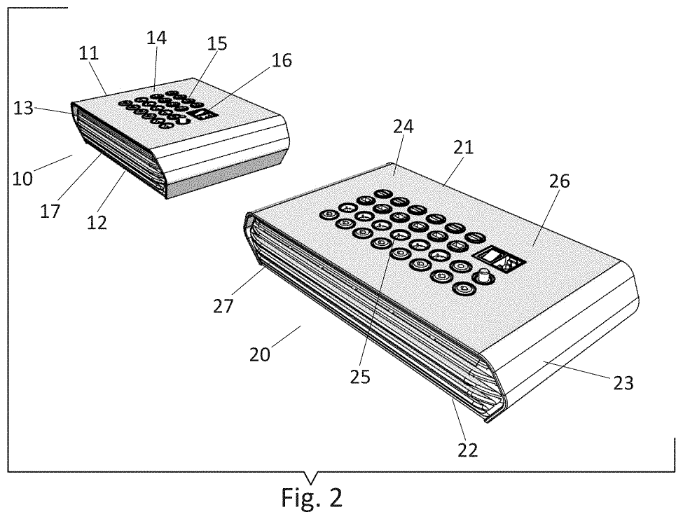

The audio control modules 10 and 20 are shown in FIG. 2 and represent simple embodiments of an audio control module as disclosed herein. These comprise a housing 11, 21 having a bottom 12, 22, walls 13, 23 and a cover 14, 24 and a number of connectors 15, 25 adapted for connecting electrical signal cables to the audio control module. The connectors 15, 25 comprise at least four analog input connectors for receiving analogue sound signals from a connected device such as microphones, electric or electronic musical instruments and other external equipment. The connectors 15, 25 also comprise digital connectors for transmitting and/or receiving digital signals representing processed audio signal and/or control and communication signals.

The digital connectors are for example adapted to connect an audio control module to a mixer module.

The audio control modules in this embodiment also comprise a power switch 16, 26 and power input for powering the audio control module. Alternatively, the audio control module may receive power through the input connectors.

Inside the housing 11, 21 there is arranged a processing unit connected to the analog and/or digital input connectors 15, 25 and adapted to processing signals received through the input connectors.

Digital audio signals and power signals are preferably conveyed over a low power cable such as, for example, an ISO Category 5 (“CATS”) or Category 6 cable or a modified version thereof. For example, a CATS cable may be combined with a 4-30 conductor speaker wire to form a modified CATS cable that carries both the digital audio and communication signals and the variable power signals for the amplifiers. Other cable types may also be used, including cables rated for low voltage/current.

The devices chosen by the user are connected to the audio control module through the input connectors, and the processing unit will process the input signals 35 according to settings which may be set by the user or preset. The user can influence the settings by connecting to an external processing device such as a smartphone, tablet, computer, portable media device, etc. The processing unit may comprise or be connected to off-the-shelf audio processing software, for example the Dante® system from Audinate Pty. Ltd. Dante is a combination of software, hardware, and network protocols that delivers uncompressed, multi-channel, low-latency digital audio over a standard Ethernet network.

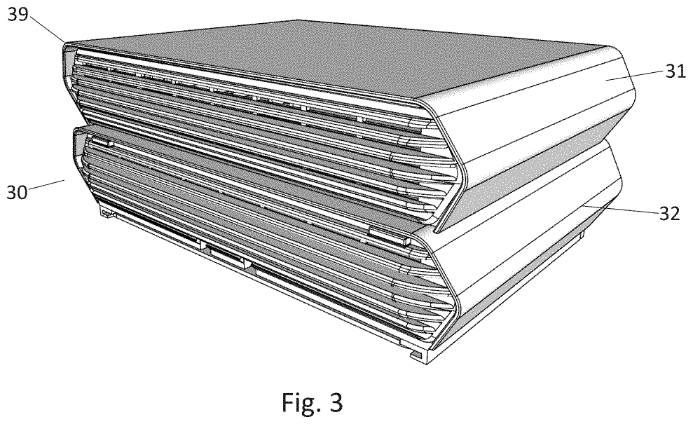

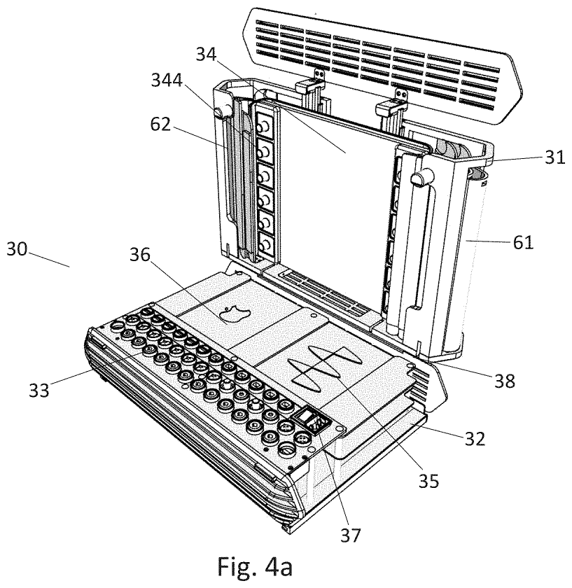

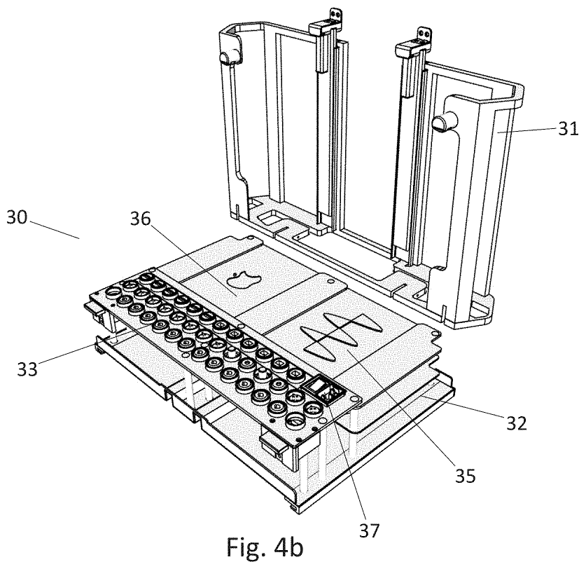

Another embodiment of an audio control module 30 is illustrated in FIGS. 3, 4a, and 4b. This module is basically identical to the audio control module 10 and 20 in FIG. 2, but comprises some added features. This module 30 comprises two sections, an upper section 31 and a lower section 32, covered by a housing 39 covering both sections. All the operating elements of audio control module 30 are arranged inside the two sections 31, 32 in housing 39, and the housing can be opened and closed. The upper section and the lower section are in this embodiment hinged together by means of hinges 38, facilitating the opening and closing. FIGS. 4a and 4b show audio control module 30 without the outer housing in an opened state. In FIG. 4a all the operating elements are placed inside the housing, while FIG. 4b shows the same embodiment where the elements in the upper section 31 have been removed.

Inside the lower section 32 of the housing there is space for a processing unit 35, a computer 36, connectors 33, and power switch 37. The computer may be any computer such as a tablet computer or other suitable computing device able to process and run a computer program. The computer can be connected to other processing/computing devices, for example the Dante® system as described above. In some embodiments, the processing unit 35 and the computer 36 may be incorporated in the same processing device. In the upper section 31, there is room for a midi unit 34. All the parts can be taken out of the housing, but normally only 25 the midi unit 34 is removed out during use. The midi unit 34 comprises midi controllers 344 and a display base 34. The display base 34 provides a support for an iPad or other kind of display device. The iPad or display device may be stored in the upper part, in contact with the display base 34. The display base 34 can be connected to a stand leg providing a stand which makes the display device easily accessible for the user. The stand leg can be comprised of two pairs of leg parts 61, 62, which can be stored inside the housing in the upper part 31. In the example embodiment, the upper part has two leg compartments which are adapted to the form and size of the pairs of leg parts 61, 62 on each side of the display base 34. The stand will be described in more detail below. 35

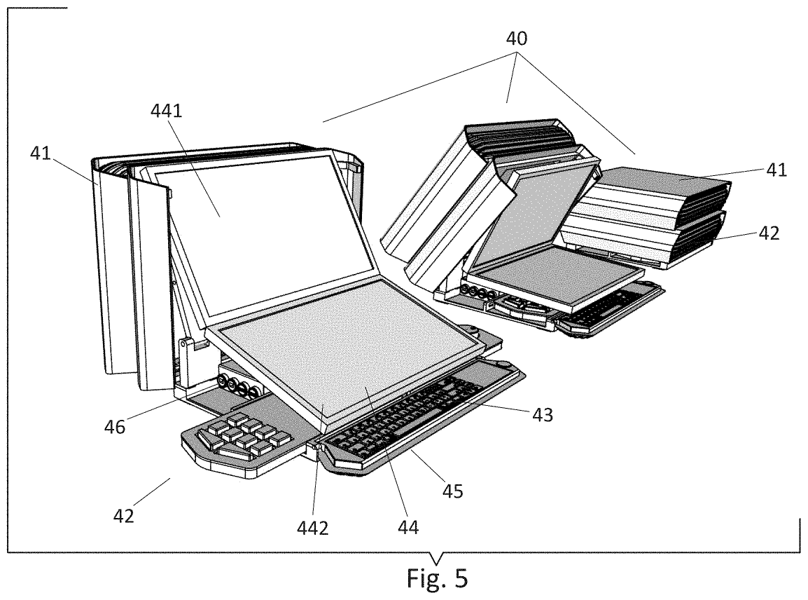

FIGS. 5 to 8 give a closer look on details and features of an example of a mixer module 40 in various steps in the process of folding/unfolding the module.

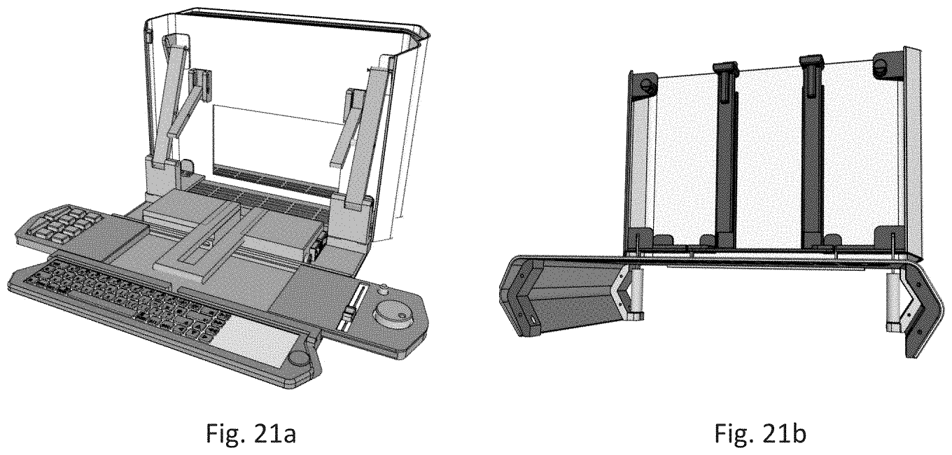

The designs and structure of the modules may vary, for example for a lighter or stiffer construction. FIG. 21 shows two design variations of the examples in FIGS. 5-8.

The mixer module 40 comprises, as the previous described modules, a housing 41 which have a bottom, walls, and a cover and at least four input connectors 46 adapted for connecting electrical signal cables to the audio control module. The input connectors are in one embodiment digital connectors for transferring digital signals to the mixer module. Inside the housing 41 there is arranged a processing unit connected to the input connectors 46 and adapted to processing signals received through the input connectors.

This module comprises two sections, an upper section 41 and a lower section 42, enclosing the housing. The upper and lower sections are in a hinged connection and the mixer module can be folded together with the upper and lower section 41, 42 on top of each other for transport and unfolded for use. Inside the housing 41 there is arranged a processing unit connected to the input connectors 46 and adapted to processing signals received through the input connectors. The processing unit may be a computer adapted to execute a computer program for processing the input signals. A display 44, for example a touch screen, is connected to the processing unit and the processing unit can comprise a computer program (software) that represents an interface between the processing and a user, thus enabling the user to influence the signal processing.

The input signals are, as described earlier, digital audio signals. The mixer module 40 can receive digital audio signals from one or a plurality of audio control modules and combine the signals to provide a desired mixed output audio signal. The mixer module is typically operated by a sound engineer who can control the processing of the input audio signals by manipulating the user interface set up by the computer program comprised in the processing unit of the mixer module 40.

The mixer module 40 comprises or is connected to further input devices such as keyboard 43, slider 49, and midi controller 42, 45 that is connected to the processing unit and can be used to manipulate the audio signals. The input devices are all arranged on slides that can be inserted into the mixer module 40 during transport or idle time and pulled out for use.

The display 44 comprises two parts 441, 442 connected and foldable together, for example by means of a hinge mechanism. Thus, when the upper and lower sections 41, 42 are folded together, the display parts 441, 442 will correspondingly fold 35 together. This process is illustrated in FIG. 5. A first stage (farthest left) in FIG. 5 shows the mixer module 40 unfolded and ready for use. A second stage (centered) in FIG. 5 shows the upper part has been partly folded towards the lower part, and the slides comprising input devices are partly inserted into the housing by sliding them in towards the center of the module below the lower display part 442. A third stage (farthest right) in FIG. 5c shows the upper and lower section 41, 42 having been completely folded together, forming a compact module ready for transport. The upper and lower sections 41, 42 may comprise locking means for locking the mixer module 40 in the folded position. This can be done for transport, but the locking means may also be locked during use in order to prevent tampering with the audio processing.

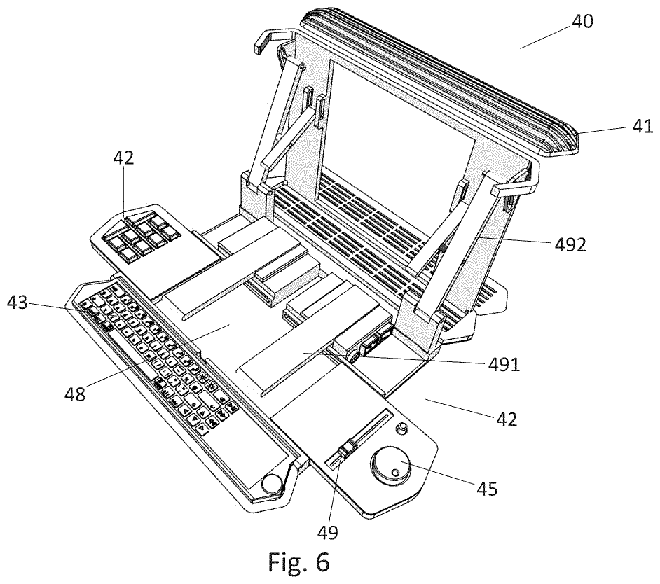

FIG. 6 shows the mixer module 40 without the display. The mixer module comprises supports 491, 492 that supports and hold the display parts when the display is in place.

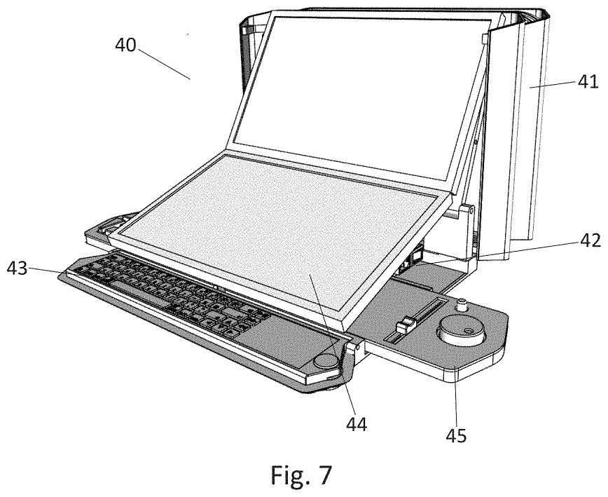

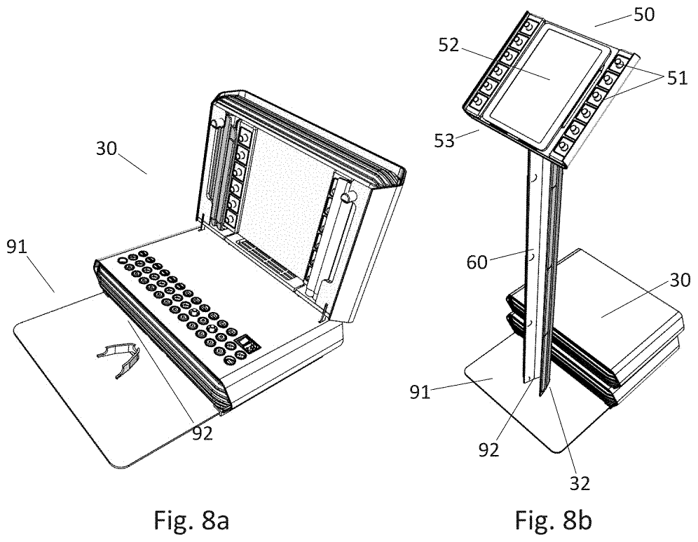

FIGS. 8a and 8b show an example of an audio control module with interface for a stand 50.

FIG. 8a shows the module before the stand is mounted and FIG. 8b shows a stand mounted at the interface.

The interface comprises a male part 92 connected to a base plate 91 of the audio control module 30. The base plate 91 may be inserted into the lower section 31 of the audio control module 30 when not in use and pulled out for mounting the stand. The stand 50 comprises a stand leg 60 and a midi unit 50 comprising midi 15 controllers 51 and a display base 53. The display base 53 is designed to accommodate an iPad 52, Android tablet or other display device able to run a software module/app. The iPad 52 comprises software for providing an interface to the processing unit 35.

MIDI controllers typically have some type of interface that the performer presses, strikes, blows, or touches. This action generates MIDI data (e.g., notes played and their intensity), which can then be transmitted to a MIDI-compatible sound module, synthesizer, or computer.

FIG. 9 shows an example of a stand leg 60. The stand leg 60 comprises in this example two pieces, but there may be more or less pieces, as the number of pieces can be adapted to achieve the desired height of the stand leg 60. In the stand leg 60 in FIG. 8, there are four pieces. In the figure two pieces of a stand leg are illustrated, in form of elongated elements 61, 62 which are configured to connect together to form a leg. The upper element 61 comprises in one end an interface section 65 for connecting to a display base as described above. In the other end, the upper element 61 comprise a connecting section 63, which is adapted to connect to a complementary section in one end of the lower element 62. In its other end, the lower element 62 comprises the female part 66 of the stand interface as described in FIG. 9.

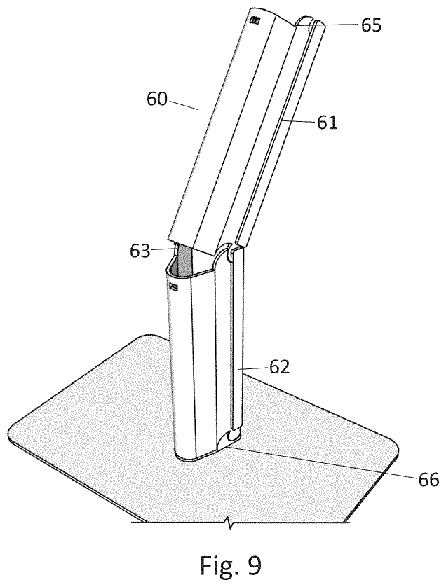

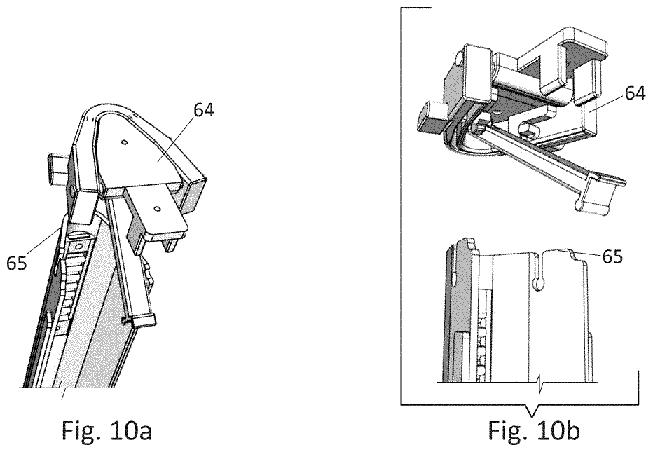

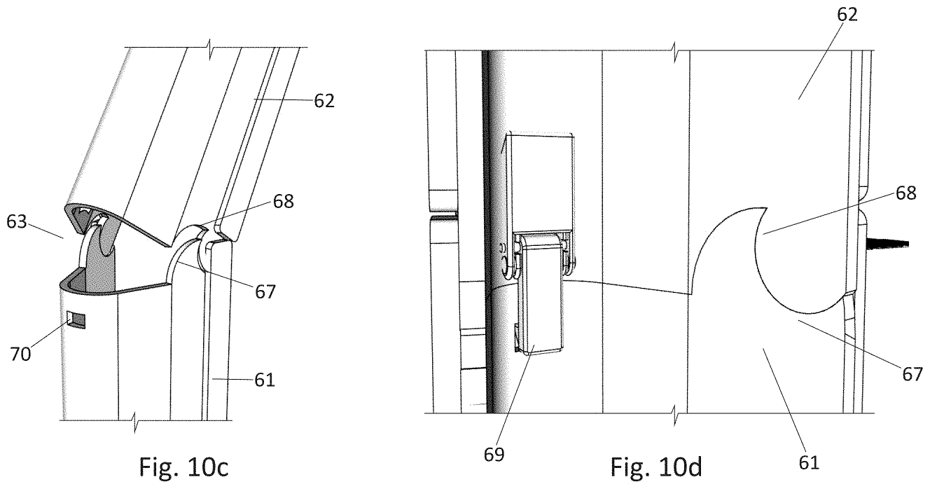

FIGS. 10a-10d show details of the stand leg. FIGS. 10a and 10b shows examples of the 35 interface 64 adapted to be connected to interface section 65 in the upper part of stand leg 60. FIGS. 10c and 10d illustrate the interconnecting mechanism 63 for interconnecting and holding together the upper and lower elongated elements 61, 62. The interconnecting mechanism 63 comprises complementary shaped edge regions 67, 68 where the male edge region 67 can be inserted into the female edge region 68 for a secure fit. Locking means are provided for locking the two elongated elements together. The locking means may for example be a latch 69 configured to be secured in a locking recess 70.

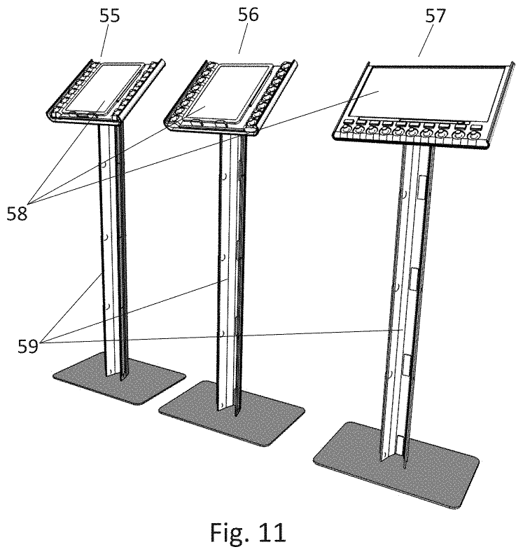

FIG. 11 shows an example of three types of stands 55, 56, 57. The different stands have different functionality, where stand 55 is the simplest stand and stand 57 is the most sophisticated, having most functions. The stands have all a display 58 which is capable of running and displaying software in form of an app or a computer program. All the stands 55, 56, 57 are connected to a stand leg 59, for example the stand leg described in one of the previous figures.

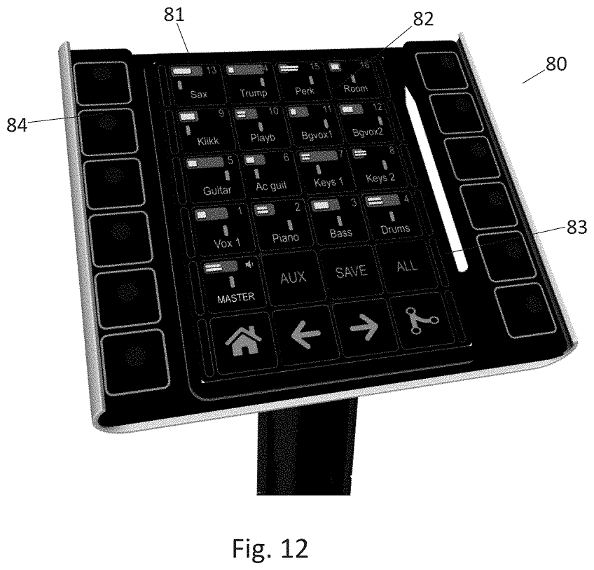

FIG. 12 shows an example of a display unit 81 mounted in a stand 80. The display unit 81 is as described above for example an iPad, Android tablet or other tablet computer with the mixer display software installed. It is of course also possible to have a dedicated mixer display integrated in the stand.

The mixer display 81 comprises certain functions which may be necessary for operating the mixer. Such functions can be one or a combination of the following.

One exemplary function may include a home page providing oversight and starting point.

Another exemplary function may include a channel overview displaying various plugins and more.

Another exemplary function may include an “all” page displaying all the channels input into the system. There may for example be 60 channels, and these may be sorted into different pages which can be accessed by swiping or turning pages going forward and back (for example, there may be 20 channels on each page).

Another exemplary function may include auxiliary channels, for example physical input which can be accessed by the software to forward for example to monitors, in-ear systems and more.

Another exemplary function may include various plug-in pages where users control plug-ins added to the software.

Another exemplary function may include gain control and pre and post options.

Another exemplary function may include a routing page where the operator can set up the mixer and how the connected audio control modules are connected.

Another exemplary function may include a save page for managing presets and saving a session such as a concert or practice, etc., for example options for saving anything from one channel to the whole mixer set up for easy access later.

Another exemplary function may include a text page for customized naming of features of the mixer such as channels, sending aux-outputs, etc.

The display 81 illustrates a home page where the upper part 82 shows channels and the lower part 83 gives access to other functions in the system.

At each side of the display 81, there are midi controllers 84 that can be used to control the audio stream.

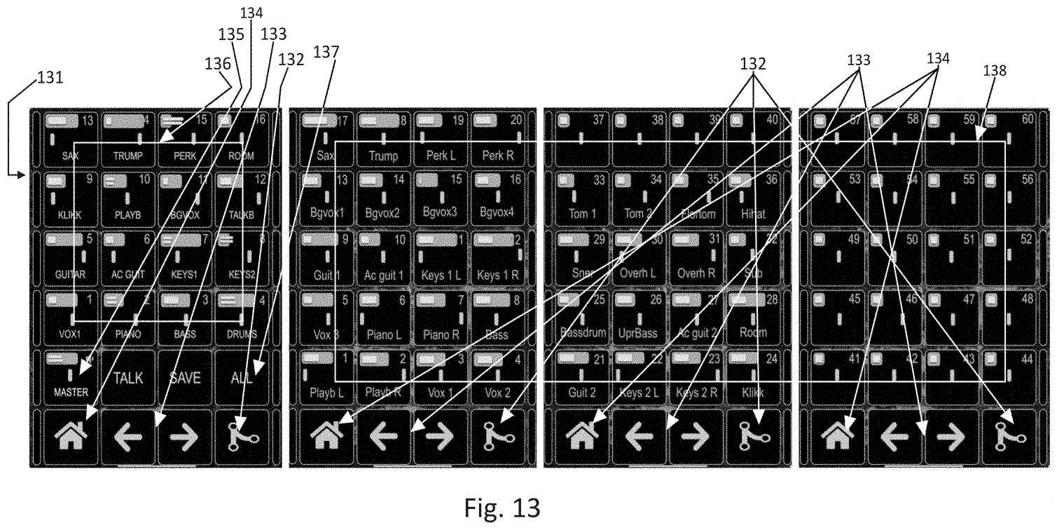

The different pages and associated controls are shown in FIGS. 13-20. In the following the interfaces shown are described and how they can be used for controlling the mixer units. The interfaces comprise in the described examples a touch sensitive surface, such that “buttons” on the interface can be pressed/touched to cause an action in the associated software.

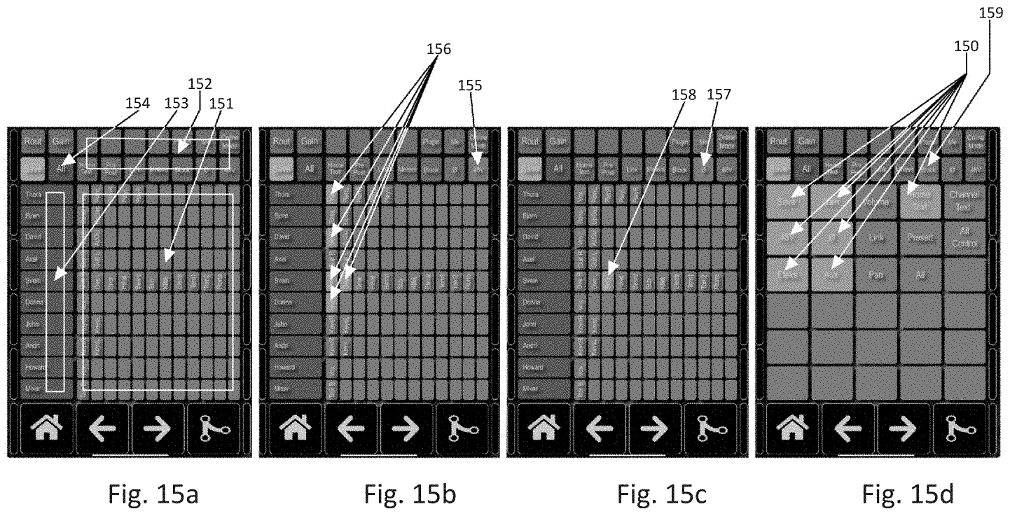

FIG. 13 illustrates an example of a main homepage 131. This page can be accessed at any time by pressing the “home” button 134 in any active interface. The main homepage 131 further comprises routing page opening button 132, which can be used to open a routing page, which will be described in FIG. 15, back and forward buttons 133, a master button 135 and sixteen summing channels 136. The back and forward buttons 133 can be used to flip pages and are present in most of the interfaces. The sixteen summing channels 136 can be used for quick access to the interface for each mix unit. The main homepage 131 also comprises an All button 137. Touching the All button 137 opens the interfaces 138 for each sub-20 channel from the mixer units. In this example there are 20 sub-channels on three pages, giving a total of 60 channels. The pages can be accessed by using the back and forward buttons 133.

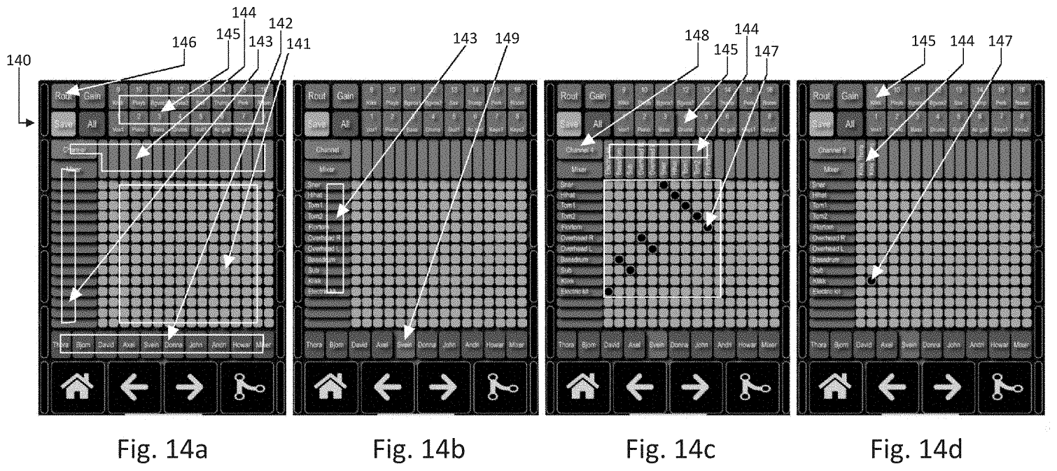

FIGS. 14a-14d illustrate examples of a routing page 140 in four states of use. The routing page 140 is used to route the channels according to the user's choice in a routing grid 141. The lower part of the routing page 140 comprises the names of the mixer units 142, a channel column 143 shows the channels of a chosen mixer, a custom channel row 144 shows the sub-channels on a chosen custom channel, and the upper part comprises the sixteen summing channels 145, which are the same as the summing channels 136 of the main homepage. FIG. 14a shows the state where no mixer is chosen. In FIG. 14b, the mixer unit 149 is chosen, in this example having the name “Svein”, and the channel column 143 comprises the names of the channels of this mixer unit. In FIG. 14c the routing is done and is illustrated by black dots 147 in the routing grid. The black dots shows the routing between the custom channels and the sub-channels. FIG. 14d illustrates the situation where the “klikk” channel in mixer unit “Svein” is routed to summing channel 148 number 9, illustrated by a dot 147.

This page also comprises interface for four main functions (Rout 146, Gain, Save, All) in the upper left corner for redirecting to other interfaces which will be described in the following.

FIG. 15 illustrates an example of an All page. This page can be accessed by pressing the All button 137 in FIG. 13 or in another page by pressing the All 5 button 154 in the interface for the four main functions. FIG. 15a illustrates the All page overview comprising channel grid 151, the mixer units 153 on the left side, and a number of function buttons 152 in the upper part.

FIG. 15b illustrates the situation after pressing a function button, in this example “48V” button 155. This button selects and shows channels that need phantom power. After pressing button 155, the activated buttons 156 are highlighted.

FIG. 15c illustrates the situation after pressing a function button, in this example “∅” button 157. This button flips the phase on one of two channels from the same source, for example when using several microphones. After pressing button 157, the activated buttons 158 are highlighted.

FIG. 15d illustrates the situation after pressing a function button, in this example “Block” button 159. This button controls which functions other connected users are disallowed to access, e.g., other mixers connected are blocked from controlling the chosen functions. After pressing button 159, the activated functions 150 are highlighted.

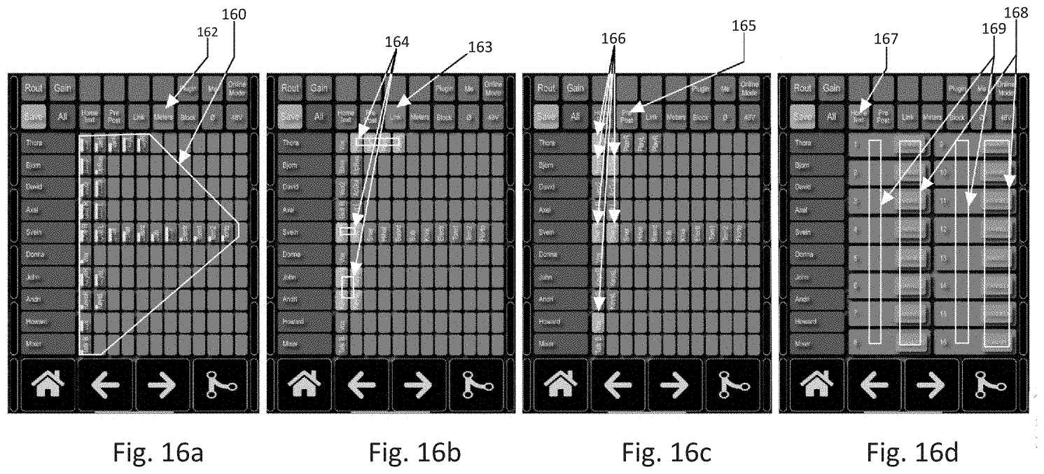

FIGS. 16a-16d illustrate further situations after pressing function buttons.

FIG. 16a illustrates the situation after pressing a function button, in this example “Meters” button 160. This button activates signal lights 162 on the channels.

FIG. 16b illustrates the situation after pressing a function button, in this example “LINK” button 163. This button links channels together, e.g., when controlling one, both channels are controlled simultaneously. After pressing button 157, the activated channels 164 are highlighted.

FIG. 16c illustrates the situation after pressing a function button, in this example “Pre/post” button 165. This button turns on/off effects from individual mixers. If a user does not like “Svein's” equalizer, the user may turn off the equalizer signal and receive a “dry sound” from that mixer. After pressing button 165, the activated mixers/channels 166 are highlighted.

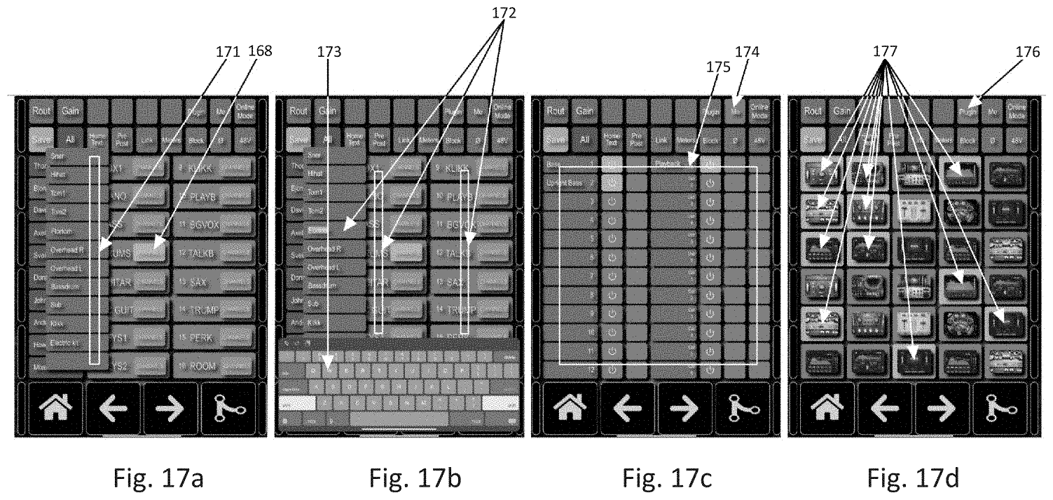

FIG. 16d illustrates the situation after pressing a function button, in this example “Home Text” button 167. This button activates a home text page (see FIG. 17) where a description for the summing channels 169 can be edited according to the user's wishes. The text buttons 168 shows the channels added into a summing channel.

FIGS. 17a-17d illustrate the Home Text page. Pressing text button 168 shows all the channels 171 added into the summing channels. Touching the buttons 172 activates a keyboard 173 for typing the desired text for editing the channel name/text.

FIG. 17c illustrates the situation where the user's own mixer is displayed for control after pressing the “Me” button 174. Input/output controls 175 are displayed, which allows the user to connect the mixer to for example a computer, USB ports, etc., e.g., enabling the organization of signal flow (digital and analogue) into the user's own mixer.

FIG. 17d illustrates the situation after pressing the “Plugin” button 176. This allows the user to activate any plugin (software module) comprised in the mixer software. The user can choose which plugin to use, for example an equalizer, compressor, signal manipulating plugins, etc. The activated plugins 177 are highlighted.

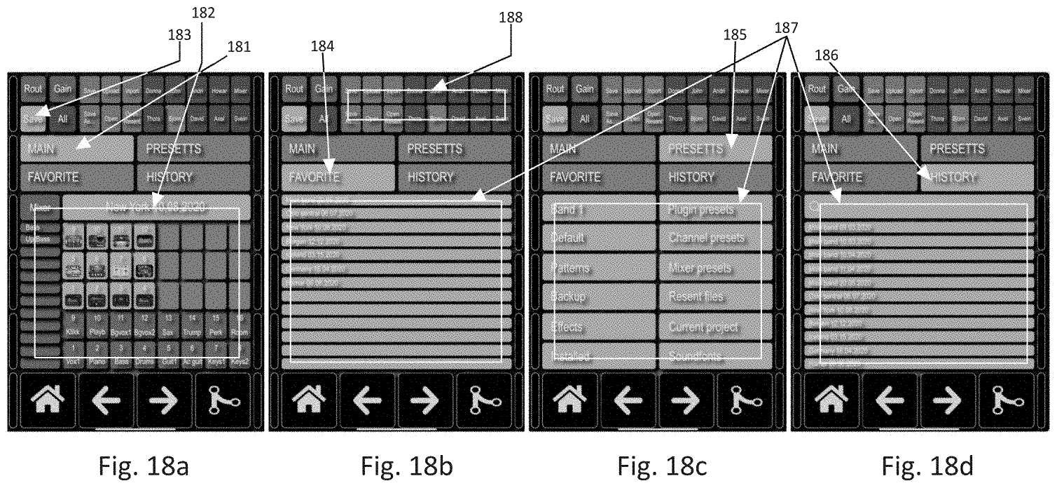

FIG. 18 illustrates the situation after having accessed the main function “save” 182, thus showing the “save” page. This page allows the user to quickly save settings and comprises four sub-functions, MAIN, FAVORITE, PRESETTS, HISTORY, as well as controls 188. FIG. 18a illustrates the situation after pressing the MAIN button 181 which opens the main controls 183. FIGS. 18b, 18c, 18d illustrate the sub-pages after selecting “favorite” 184, “presets” 185 and “history” 186. This opens different save lists 187.

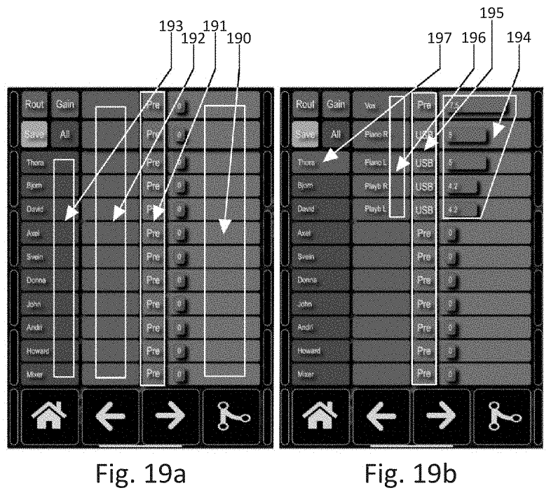

FIG. 19 illustrates the situation after having accessed the main function “Gain”, thus showing the “gain” page. In FIG. 19a all the mixers 193 connected together in a network are displayed, and the page further displays gain volume controller 190, “Pre/post” controller 191 for selecting source type, and channels 192 for the mixers.

FIG. 19b shows the situation where the mixer “Thora” 197 have been chosen, the mixer having a number of channels 196, connected through source 195. The power indicators 194 can be touched in order to change the power for each channel.

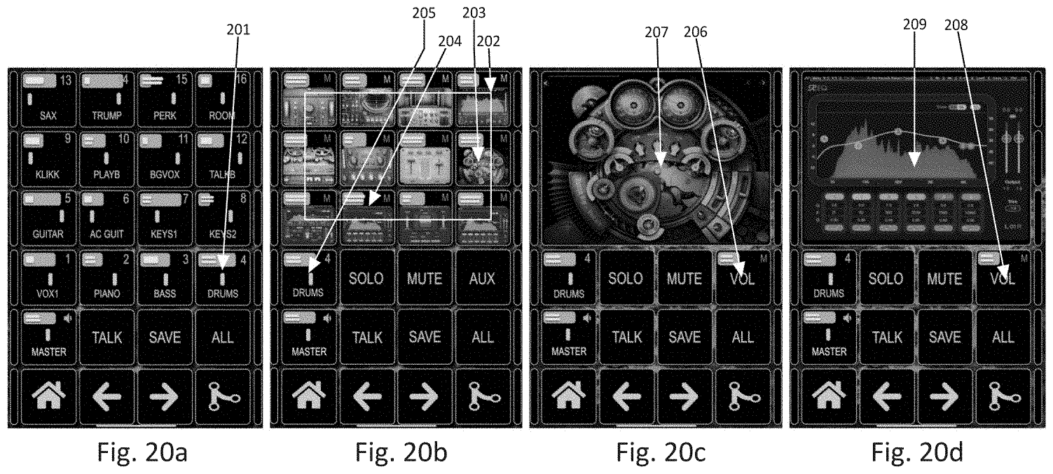

FIGS. 20a to 20d show the sub pages of the main home page (FIG. 13). In the example, “Drums” button 201 has been activated/pressed in FIG. 20a, opening the drum plugin page illustrated in FIG. 20b. This example mixer comprises twelve plugins 202 for the drums which can be selected. In FIG. 20b two plugins 203, 204 have been selected. Selecting one plugin 203, opens the plugin page for this particular plugin, illustrated in FIG. 20c, comprising plugin controls 207 and plugin volume 35 button 206. FIG. 20d illustrates an example another plugin page for another plugin, similarly comprising plugin controls 209 and plugin volume button 208.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. An audio control module for controlling sound during a live performance, comprising:
a housing having a bottom, walls, and a lid;
at least four audio input connectors configured to receive sound signals via connected electrical signal cables;
a processing unit connected to the audio input connectors and configured to process the signals received through the audio input connectors, based at least in part on audio control settings provided via user input associated with one or more of the sound signals; and
one or more digital connectors connected to the processing unit and configured to communicate with another audio control module at least by transmitting signals processed by the processing unit.

2. The audio control module of claim 1, wherein the user input is provided to the audio control module via an external computing device.

3. The audio control module of claim 2, wherein the user input further provides audio control settings for processing sound signals associated with one or more other audio control modules during the live performance.

4. The audio control module of claim 1, comprising one or more analog connectors connected to the processing unit, wherein the processing unit is configured to process analog signals received via the one or more analog connectors and to convert said analog signals to digital signals.

5. The audio control module of claim 4, wherein the one or more analog connectors number 4, 8, or 12 analog connectors.

6. The audio control module of claim 1, further comprising a display unit and wherein the housing is configured to contain the display unit.

7. The audio control module of claim 6, comprising a stand for the display unit, wherein the stand comprises a stand leg and a display base, and wherein the housing is adapted to contain the stand leg inside the housing.

8. The audio control module of claim 7, wherein the stand leg comprises at least two elongated elements and where the two elongated elements each comprise complementary shaped edge regions for fitting securely together.

9. The audio control module of claim 8, comprising locking means for locking the complementary shaped edge regions together.

10. An audio control system for providing controlled sound output from audio sources during a live performance, the system comprising a plurality of independent audio control modules according to claim 1 and a mixer module, where the mixer module comprises a number of input connectors for connecting to the audio control modules and a processing unit connected to the input connectors, wherein the processing unit is configured to receive audio signals from the plurality of audio control modules and combine the signals to provide a desired mixed output audio signal.

11. The audio control system of claim 10, where the mixer module comprises a computer program comprised in the processing unit.

12. The audio control system of claim 10, comprising one or more input devices connected to the processing unit and configured to manipulate the audio signals.

13. The audio control system of claim 10, wherein at least one of the one or more digital connectors are configured for connecting the audio control modules to the mixer module.

14. The audio control system of claim 10, where the mixer module comprises a housing and the input devices are arranged on slides that can be inserted into or pulled out of the housing.

15. A method of controlling sound during a live performance, comprising:
providing independent audio control modules for each of a plurality of performers during the live performance, wherein each of the audio control modules comprises at least four audio input connectors configured to receive sound signals from audio sources associated with the respective performer via connected electrical signal cables; and
for each of the plurality of audio control modules,
receiving user input from the respective performer at a processing unit connected to the audio input connectors, said user input associated with one or more of the sound signals,
processing the sound signals received through the audio input connectors, based at least in part on audio control settings provided via the user input, and
transmitting signals processed by the processing unit for communication with each of the other audio control modules.

16. The method of claim 15, wherein the user input is provided to the audio control module via an external computing device.

17. The method of claim 16, wherein the user input further provides audio control settings for processing sound signals associated with one or more other audio control modules during the live performance.

18. The method of claim 15, further comprising:
providing a mixer module in communication via input connectors with each of the plurality of audio control modules and a processing unit connected to the input connectors;
and combining the sound signals from each of the plurality of audio control modules to provide a desired mixed output audio signal.
